(19) United States
(12) Patent Application Publication
(10) Pub. No.: US 2004/0035007 A1
(43) Pub. Date: Feb. 26, 2004

(54) Attachment for a percussive tool

(76) Inventor: John Elliott Burgess, Middlesborough (GB)

Correspondence Address: BEYER WEAVER & THOMAS LLP, P.O. BOX 778, BERKELEY, CA, 94704-0778, US

(21) Appl. No.: 10/221,631

(22) PCT Filed: Mar. 9, 2001
(86) PCT No.: PCT/GB01/01048

(30) Foreign Application Priority Data
Mar. 13, 2000 (GB) 0006005.3

(51) Int. Cl. B26B 3/00

(52) U.S. Cl. 30/307; 30/304; 30/306

(57) ABSTRACT

An attachment for a percussive tool including at least one substantially circular chisel blade (7) having a plurality of teeth (13) around its circumference and arranged to rotate about an axis substantially perpendicular to the longitudinal axis of the percussive tool. The attachment may be used to form grooves in walls for pipes or cables, or removing filler to gain access to pipes and cables which have already been installed, or to remove mortar from brickwork.

### FIELD OF THE INVENTION

The invention concerns an attachment for a percussive tool such as so called combie drill or impact breaker. The invention concerns an attachment specifically designed to be used to form grooves in walls for pipes or cables, or removing filler to gain access to pipes and cables which have already been installed, or to remove mortar from brickwork.

### BACKGROUND TO THE INVENTION

Part of an electrician's job is to chisel out grooves in walls to receive electrical or telephone cables. The grooves are generally formed by hand chiseling. The cables are placed in the groove and are usually covered with a plastic capping prior to replastering, cement rendering or other means for filling the groove. If cables require replacing then it is also necessary to remove the filler from the groove to extract the cable.

Plumbers also often have to chisel grooves in walls for receiving pipes. Hand chiseling grooves for receiving pipes or cables is very time consuming. As above, it is also necessary sometimes to gain access to the pipes after they have been installed and the filler used to fill the grooves must be removed.

Builders often need to remove mortar from brickwork when re-pointing a building, and this is also usually carried out by hand chiseling.

DE3312019 discloses an attachment for a hammer drilling machine suitable for producing grooves. The attachment has a drill tip accommodated in a sleeve for drilling the groove and a sliding shoe which slides along the surface to be worked to guide the tool. The depth of the groove is controlled by the amount the drill tip projects beyond the bottom of the sliding shoe.

GB2195101 discloses a guide attachment for a percussive chisel designed to adapt the chisel to be suitable for removing mortar from a joint. The guide attachment includes a pair of wheels which rest on the brickwork on either side of the joint and the chisel blade removes mortar from the joint. The wheels enable the chisel to move smoothly, and the chisel blade is guided by the joint. The position of the wheels with respect to the tip of the blade is adjustable to vary the depth to which the blade removes the mortar. Another percussive tool for removing mortar which includes guide wheels is disclosed in GB2167005.

GB2255521 and GB2207280 disclose hand chisels having guide wheels.

### DISCLOSURE OF THE INVENTION

According to the present invention an attachment for a percussive tool comprises at least one substantially circular chisel blade having a plurality of teeth around its circumference and arranged to rotate about its axis.

According to a second aspect of the present invention, a method for forming a groove in a wall or removing material from a groove in a working surface comprises the steps of:

providing an attachment for a percussive tool, the attachment having at least one rotating chisel blade arranged to rotate about an axis substantially perpendicular to the longitudinal axis of the percussive tool;

connecting the attachment to a percussive tool;

placing the attachment in contact with the working surface and causing percussive action of the attachment such that the chisel blade cuts into the surface; and

causing the tool to move along the surface such that the chisel blade rotates and forms a groove in the surface.

The present invention may be used to form grooves in walls for pipes or cables, or removing filler to gain access to pipes and cables which have already been installed, or to remove mortar from brickwork.

In the present invention, the blade of the chisel is a rotatable wheel. The chisel blade is easily moved along a working surface to produce a groove, and the width of the wheel will determine the width of the groove produced. The teeth help the blade bite into the wall, allow debris to be ejected from under the blade and improve the grip of the attachment as it is rolled along the wall. The attachment of the present invention is more maneuverable than the prior art tools in which the guide wheels are separate from the blade. The prior art tools, although adequate for removing mortar from brickwork when the blade is guided by the joint, are more difficult to use to chisel a groove with no guiding joint present. The attachment of the present invention is suited for both applications.

Preferably, the attachment comprises a plurality of substantially parallel chisel blades spaced from each other. The spaces between the blades allow debris to be ejected from under the attachment as a groove is formed. This is necessary particularly when a wider groove is required. The blades may be all formed from one piece joined along their common axis to form a blade assembly such that they rotate together, but preferably each blade is individually formed. This makes the blades easier to form by methods suitable for producing metal parts to a high degree of hardness. The blades may be stamped from tooled steel and are preferably then hardened to a hardness of 54 on the Rockwell C scale. The individual blades may be freely rotatable with respect to the each other, but preferably means are provided to prevent the blades rotating with respect to each other. This prevents the teeth on the blades from aligning with the teeth on adjacent blades which will form corrugations in the bottom of the groove. Preferably, the blades are fixed with respect to each so that the teeth on each blade are not aligned with the teeth on the adjacent blades.

Preferably the attachment comprises a yoke having two arms and a spindle rotatably mounted between the arms on which the blades are mounted. Preferably the spindle is releasable such that the blades or blade assembly may be removed from the spindle. A removeable bolt may be provided which passes through two arms of the yoke and the spindle such that the spindle rotates on the bolt. Alternatively, the rotatable spindle may be mounted on a shaft fixed at both ends by spring pins. Either arrangement allows the blades to be replaced when worn or interchanged with blades suitable for different purposes. For instance, blades with different pitches of teeth may be required for cutting different materials, and blades of different diameter may be used for different depth grooves. Also, the width of the groove may be varied by the use of a different number or width of blades, or a different blade spacing. In the case of the blade assembly wherein all the blades are joined, different width blade assemblies may be used, which have either small diameter portions at each end, or separate spacers which are placed onto the spindle at each side of the blade assembly. In the case wherein the blades are separately, spacers of different sizes may be used to separate the blades. Different numbers or widths of blades may be used. Preferably the spacers are formed from nylon. This provides a highly flexible system for adapting the attachment for different uses by varying both the size and number of blades but also the size and number of spacers.

Preferably the attachment includes two guide wheels one on each side of the yoke, having a diameter smaller than that of the blades. These guide wheels run on either side of a groove being cut and the difference between the diameter of the guide wheels and the diameter of the blades controls the depth of the groove. Preferably the guide wheels are also removable and replaceable. This provides an alternative method of varying the depth of the groove, by changing the diameter of the guide wheels. Preferably the guide wheels are formed of rubber. This provides a good grip when rolling the attachment along the wall. As well as stabilizing the tool, the guide wheels also allow the angle of attack to be varied.

Preferably, the attachment comprises an attachment head and a drive impact shaft. Preferably the means for connecting the attachment to a percussive tool comprises a standard fitting such as an SDS fitting, an SDS Max fitting, or similar chucks used on percussive power tools, or other means to connect to the percussive tool. Therefore, by providing drive impact shafts having a variety of standard fittings, the attachment may be fitted to the chuck of almost any percussive tool such as a so called combie drill or impact breaker. Preferably the drive impact shaft is connected to the attachment head by means of a taper fit. Locking means may be provided to lock the taper fit in engagement. A number 2 Morse taper angles are preferably used.

The present invention is particularly suited for use in an electric hand tool capable of percussive action such as a Combie drill or impact breaker. However, it may also be used with a pneumatic percussive tool.

### BRIEF DESCRIPTION OF THE DRAWINGS

An embodiment of the present invention will now be described with reference to the accompanying drawings in which:

FIG. 1 shows a partly cross sectioned front elevation of an embodiment of the present invention;

FIG. 2 shows a partly cross sectioned side elevation of an embodiment of the present invention in use; and

FIG. 3 shows a side elevation of a single blade.

### DETAILED DESCRIPTION

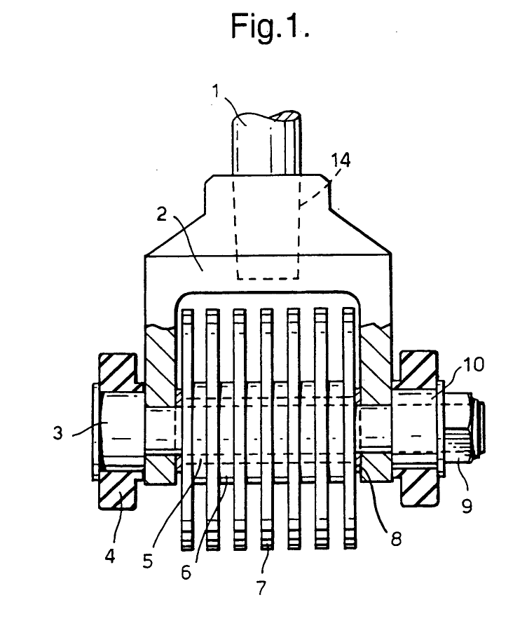

FIG. 1 shows an attachment according to an embodiment of the invention. The attachment head comprising a yoke 2 is attached to a drive impact shaft 1 by means of a taper 14. The drive impact shaft 1 is attached to a portable electric combie drill or impact breaker by means of a standard SDS Max attachment. However, the same attachment head may be fitted to a drive impact shaft having a different fitting for attachment to a drill having a different type of fitting such as a three jaw chuck.

Between the arms of the yoke 2 is a spindle 5 which is rotatably mounted between the arms on a bolt 3 which passes through both arms of the yoke 2 and the centre of the spindle 5. On each side of the yoke 2, a hard rubber guide wheel 4 is mounted on the bolt 3. At one end the guide wheel is mounted directly on the bolt, and at the other end the other wheel is mounted on a bush 10. A lock nut 9 locks the bolt in position. Shim washers 8 provide the correct clearance to allow the spindle 5 to rotate on the bolt 3.

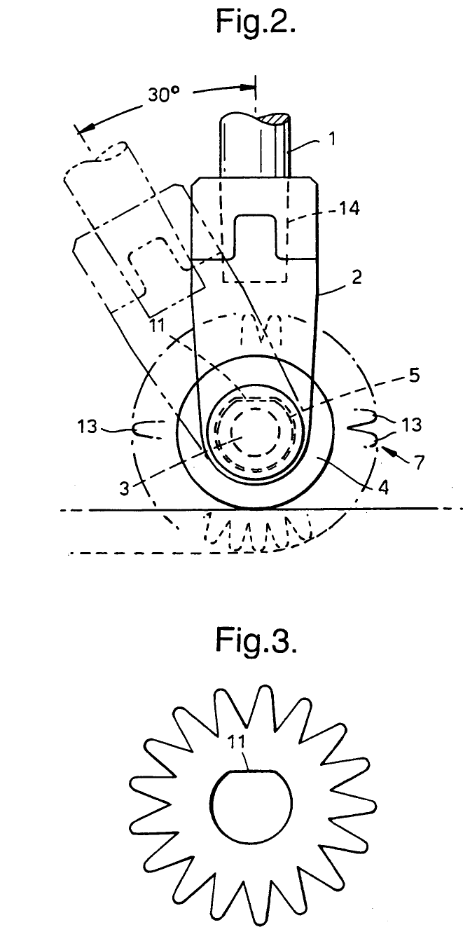

A plurality of circular blades or star wheels 7 are mounted on the spindle 5, separated by nylon spacer washers 6. Each star wheel 7 has a plurality of teeth 13 around its circumference, as shown in FIGS. 2 and 3. As shown in FIG. 3, each star wheel 7 has a flat 11 in its central bore which matches a corresponding flat on the spindle 5. This prevents the star wheels 7 from rotating on the spindle 5. Each star wheel has the flat 11 matched with either the root or the point of a tooth, and these are alternated along the length of the spindle 5. This prevents the teeth on adjacent star wheels aligning themselves and leaving a corrugated bottom in the groove.

The necessary spacing of the star wheels 7 and the pitch of the teeth 13 is partly dependent on the material in which the hole is to be chiseled. Material such as plaster which crumbles easily will not require as closely spaced star wheels 7 as a harder material such as concrete. The choice of the pitch of the teeth may also be dependant on the power of the tool. For lightweight tools it is desirable to reduce the contact area of the attachment with the wall, and so fewer teeth must be used than with a more powerful tool. To achieve the smoothest finish on the bottom of the groove it is desirable to use the maximum number of teeth appropriate for the power of tool. Similarly, the more powerful the tool, the larger the number of blades which can be used and the better the finish on the bottom of the groove.

For producing grooves for electric cables, the groove required is approximately 45 mm wide and 10-12 mm deep. This may be achieved by using seven star wheels 3.18 mm (0.125 inches) thick and 60.3 mm (2.375 inches) in diameter with nylon spacers 3.68 mm (0.145 inches) thick. This is the attachment illustrated in FIG. 1. For sinking armoured cables or pipes, a groove approximately 25 mm (1 inch) wide by 25 mm (1 inch) deep is required. A narrower yoke may be used, with the same dimension star wheels as above, but using four star wheels and three spacers. For removing mortar from brickwork, a yoke having a 12.7 mm (% inch) internal width is used, with two star wheels. In this case the width of the spacer may be changed such that the tool fits exactly between the bricks or stone. For removing pointing, it is not likely that more than two star wheels would be used.

FIG. 2 illustrates the attachment in use. To start the cut, the attachment is pushed vertically onto the surface. Once the guide wheels 4 contact the surface, the angle of attack is slowly varied until the attachment starts to move. This is usually at approximately 30° to the vertical, as shown in FIG. 2.

1. An attachment for a percussive tool comprising at least one substantially circular chisel blade (7) having a plurality of teeth (13) around its circumference and arranged to rotate about its axis.

2. An attachment according to claim 1, comprising a plurality of substantially parallel chisel blades (7) spaced from each other.

3. An attachment according to claim 1 or 2, wherein each blade (7) is individually formed.

4. An attachment according to claim 3, wherein means are provided to prevent the blades (7) rotating with respect to each other.

5. An attachment according to claim 4, wherein the blades (7) are fixed with respect to each so that the teeth (13) on each blade (7) are not aligned with the teeth on the adjacent blades.

6. An attachment according to any one of claims 3 to 5, wherein the blades (7) are separated by spacers (6).

7. An attachment according to any one of the preceding claims, comprising a yoke (2) having two arms and a spindle (5) rotatably mounted between the arms on which the blades (7) and/or spacers (6) are mounted.

8. An attachment according to claim 7, wherein the spindle (5) is releasable such that the blades (7) and/or spacers (6) may be removed from the spindle (5).

9. An attachment according to claim 7 or 8, including two guide wheels (4), one on each side of the yoke (2), having a diameter smaller than that of the blades (7).

10. An attachment according to any one of the preceding claims comprising an attachment head and a drive impact shaft (1), wherein the drive impact shaft (1) is connected to the attachment head by means of a taper fit (14).

11. A method for forming a groove in a wall or removing material from a groove in a working surface comprising the steps of:
providing an attachment for a percussive tool, the attachment having at least one rotating chisel blade (7) arranged to rotate about an axis substantially perpendicular to the longitudinal axis of the percussive tool;
connecting the attachment to a percussive tool;
placing the attachment in contact with the working surface and causing percussive action of the attachment such that the chisel blade (7) cuts into the surface; and
causing the tool to move along the surface such that the chisel blade (7) rotates and forms a groove in the surface.
